(19) United States
(12) Patent Application Publication
(10) Pub. No.: US 2009/0058580 A1
(43) Pub. Date: Mar. 5, 2009

(54) Magnetic Levitation System and Method

(76) Inventor: William R. Dunkelberger, Huntsville, AL (US)

Correspondence Address: LANIER FORD SHAVER & PAYNE P.C., P O BOX 2087, HUNTSVILLE, AL, 35804-2087, US

(21) Appl. No.: 11/846,381

(22) Filed: Aug. 28, 2007

(51) Int. Cl. H01F 7/08

(52) U.S. Cl. 335/220

(57) ABSTRACT

A magnetic levitation system has a substantially circular levitation track that is magnetically repulsive and a substantially circular propulsion track adjacent the levitation track that is magnetically repulsive. The system further has an end effector, which has a first array of magnets positioned to magnetically interface with the levitation track and a second array of magnets positioned to magnetically interface with the propulsion track to create propelling magnetic forces. The system further has a rotation device for radially rotating the end effector over the levitation track until the end effector levitates and reaches a threshold speed such that the propelling magnet forces generated by the second array of magnets and the propulsion track tend to propel the end effector radially.

### BACKGROUND

Magnetic levitation is a technology that moves objects, e.g., trains, using the magnetic repulsion forces exhibited by magnets.

With respect to a train, a magnetized coil runs along a train track, and large magnets on the undercarriage of the train are repelled by the magnetized coil. The repulsion causes the train to levitate above the train track. Once the train is levitated, power supplied to the coils creates a flow of magnetic fields that pull and push the train along the track.

### SUMMARY

A magnetic levitation system, in accordance with an embodiment of the present disclosure, comprises a substantially circular levitation track that is magnetically repulsive and a substantially circular propulsion track adjacent the levitation track that is magnetically repulsive. The system further has an end effector, which has a first array of magnets positioned to magnetically interface with the levitation track and a second array of magnets positioned to magnetically interface with the propulsion track to create propelling magnetic forces. The system further has a rotation device for radially rotating the end effector over the levitation track until the end effector levitates and reaches a threshold speed such that the propelling magnet forces generated by the second array of magnets and the propulsion track tend to propel the end effector radially.

A magnetic levitation method in accordance with an embodiment of the present disclosure comprises the steps of radially rotating a first magnet array over a substantially circular levitation track, the first magnet array fixed adjacent to a second magnet array, and rotating the second magnet array over a substantially circular propulsion track until the first magnet array repels the levitation track thereby levitating the first magnet array and the second magnetic array. The method further comprises magnetically propelling the first magnet array and the second magnet array radially.

The radial magnetic levitation engine design can replace an internal combustion engine and the associated pollution of the atmosphere. In addition, the design may eliminate the need for importing foreign oil.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1A is a top perspective view of a magnetic levitation system (MLS) in accordance with an embodiment of the present disclosure.

FIG. 1B is a top plan view of the MLS depicted in FIG. 1A.

FIG. 1C is a first side plan view of the MLS depicted in FIG. 1A.

FIG. 1D is a second side plan view of the MLS depicted in FIG. 1A.

FIG. 1E is a bottom perspective view of the MLS depicted in FIG. 1A.

FIG. 1F is a bottom plan view of the MLS depicted in FIG. 1A.

FIG. 2 is an exploded view of the upper portion of the MLS depicted in FIG. 1A.

FIG. 3 is an exploded view of the lower portion of the MLS depicted in FIG. 1A.

FIG. 4 is an exploded perspective view of an exemplary rotating armature and an exemplary levitation/propulsion assembly ring in accordance with an embodiment of the present disclosure of the MLS depicted in FIG. 1A.

FIG. 5 is an assembled perspective view of the rotating armature ring and the levitation/propulsion assembly ring of the MLS depicted in FIG. 1A further depicting an exploded view of a plurality of support rods in accordance with an embodiment of the present disclosure.

FIG. 6 is an exploded perspective view of an exemplary upper support frame and the assembled rotating armature and the levitation/propulsion assembly ring as depicted in FIG. 5 in accordance with an embodiment of the present disclosure.

FIG. 7 is an exploded perspective view of the MLS 1 depicted in FIG. 1A and an upper bearing cover and closeout flange in accordance with an embodiment of the present disclosure.

FIG. 8 is a top plan view of the assembled rotating armature ring and the levitation/propulsion assembly ring as depicted in FIG. 5 further depicting an exemplary levitation and propulsion track in accordance with an embodiment of the present disclosure.

FIG. 9 is a top plan view of the assembled rotating armature ring and the levitation/propulsion assembly ring as depicted in FIG. 5 further depicting an exemplary levitation and propulsion track cover in accordance with an embodiment of the present disclosure.

FIG. 10 is a drawing illustrating spline mating between a splined shaft and a splined flange of the MLS depicted in FIG. 1A in accordance with an embodiment of the present disclosure.

FIG. 11 is a top perspective view of an exemplary end effector of the MLS depicted in FIG. 1A.

FIG. 12 is a bottom perspective view of the exemplary end effector of the MLS depicted in FIG. 11.

FIG. 13 is a top plan view of the exemplary end effector of the MLS depicted in FIG. 11.

FIG. 14 is a side plan view of the end effector depicted in FIG. 11.

FIG. 15 is a bottom plan view of the end effector depicted in FIG. 11.

FIG. 16 is an outside end plan view of the end effector depicted in FIG. 11.

FIG. 17 is a cross-sectional view of the MLS depicted in FIG. 1A when the MLS is in an off position and is at rest.

FIG. 18 is a cross-sectional view of the MLS depicted in FIG. 1A when the MLS is levitating.

FIG. 19 is a flowchart depicting an exemplary magnetic levitation method of the MLS 1 of FIG. 1A in accordance with an embodiment of the present disclosure.

### DETAILED DESCRIPTION

Embodiments of the present disclosure generally pertain to magnetic levitation systems and methods. In particular, the present disclosure describes a magnetic levitation engine for use in a vehicle or appliance, such as for example, automobiles and/or home alternating current (A/C) power units. The system can be enlarged as needed to meet particular horsepower requirements.

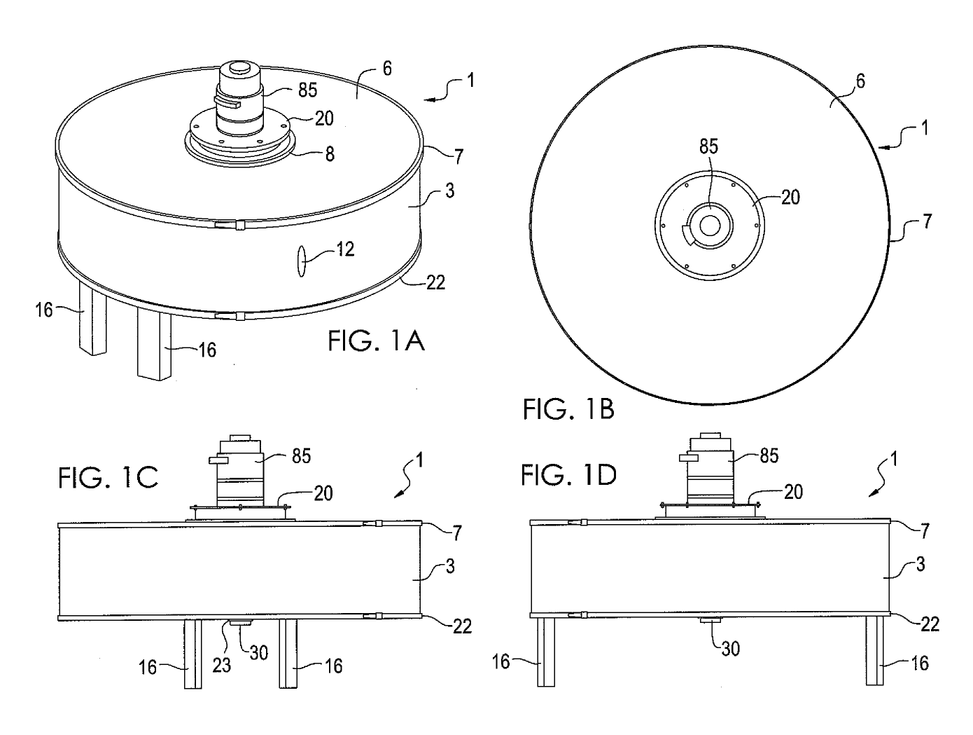

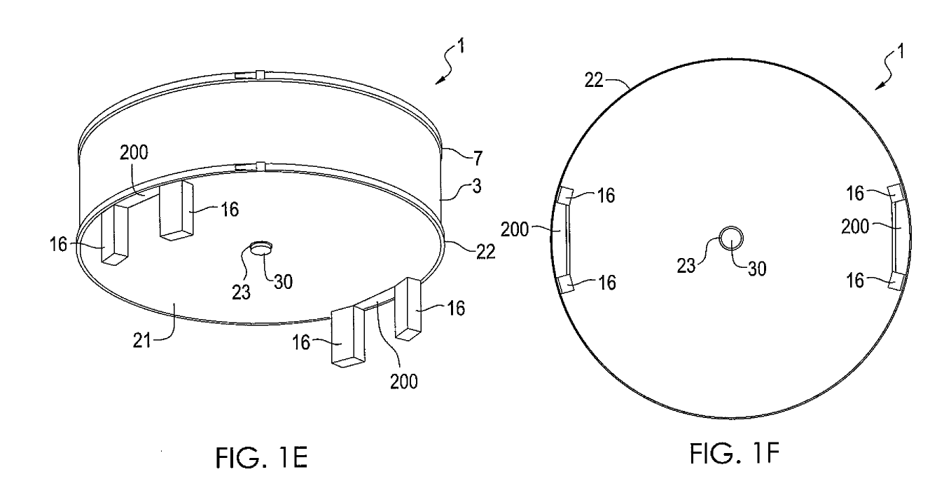

FIGS. 1A-1F depict varying views of an exemplary assembled magnetic levitation system (MLS) 1 in accordance with an embodiment of the present disclosure.

FIG. 1A depicts a top perspective view of the MLS 1. The MLS 1 comprises an upper lid 6, which is attached to a barrel 3 via an upper attachment ring 7. The MLS 1 also comprises a lower attachment ring 22, which is described further herein with reference to FIG. 1E. The MLS 1 further comprises a starter/generator 85 that couples to a standoff flange 20, and the standoff flange interfaces to the upper lid 6 via a gasket 8.

In addition, the MLS 1 comprises one or more support rods 16. In one embodiment, the support rods 16 attach to a frame (not shown) of a vehicle (not shown), thereby securing the MLS 1 to the vehicle.

The barrel 3 further comprises a sensor aperture 12. As will be described further herein, the MLS 1 comprises a plurality of mechanical parts that rotate. Through the sensor aperture 12, a sensor (not shown) monitors and measures quantifiable aspects of the rotating parts. For example, an accelerometer (not shown) may be placed within close proximity to the sensor aperture 12, and the accelerometer can monitor and measure the velocity of the rotating parts. Measurements made through the aperture 12 may be used by a central instrumentation system (not shown) presently known in the art or future-developed to control the MLS 1.

FIG. 1B depicts a top plan view of the MLS 1 depicted in FIG. 1A. In this regard, FIG. 1B depicts the upper lid 6 and the attachment ring 7, which couples the upper lid 6 to the barrel 3 (FIG. 1A). As described hereinabove, the closeout flange 20 couples to the starter/generator 85.

FIG. 1C depicts a side plan view of the MLS 1 depicted in FIG. 1A. With respect to FIG. 1C, the MLS 1 further comprises a splined shaft 30. Most of the splined shaft 30 is housed within the MLS 1. However, the side-plan view of FIG. 1C depicts the splined shaft 30 as it extends slightly from the MLS 1. Furthermore, a gasket 23 surrounds the splined shaft 30 to ensure that foreign substances and/or objects do not interfere with any rotating parts of the MLS 1, described further herein. When the MLS 1 is assembled, the closeout flange 20 connects the starter generator 85 (FIG. 1A) to the splined shaft 30. Thus, when the starter generator 85 rotates, it initiates rotation in the MLS 1 through the splined shaft 30, which is described further herein.

FIG. 1C shows a first side plan view that depicts two support rods 16, whereas FIG. 1D depicts a second side plan view that depicts placement of additional support rods 16, which are described further with reference to FIG. 1E. The MLS 1 has eight support rods 16, including four that extend from the MLS 1 and four that are encompassed within the MLS 1 and not visible in FIGS. 1A-1F. Such support rods are described further herein.

FIG. 1E depicts a bottom perspective view of the MLS 1 depicted in FIG. 1A. The MLS 1 further comprises a lower cover 21 that is attached to the barrel 3 via the attachment ring 22 much like the upper lid 6 is attached to the barrel 3 via the attachment ring 6.

FIG. 1E illustrates four support legs 16 that extend through one or more openings 200 in the lower cover 21. As described hereinabove, the support rods 16 shown may extend to the frame (not shown) of the vehicle (not shown), thereby attaching the MLS 1 to the vehicle. Furthermore, as described hereinabove, there may be additional support rods 16 that are not visible in FIGS. 1A-1F, but shall be discussed further herein.

FIG. 1F depicts a bottom plan view of the MLS 1 depicted in FIG. 1A. Notably, FIG. 1F depicts the openings 200 in the bottom cover 21 through which the support rods 16 extend.

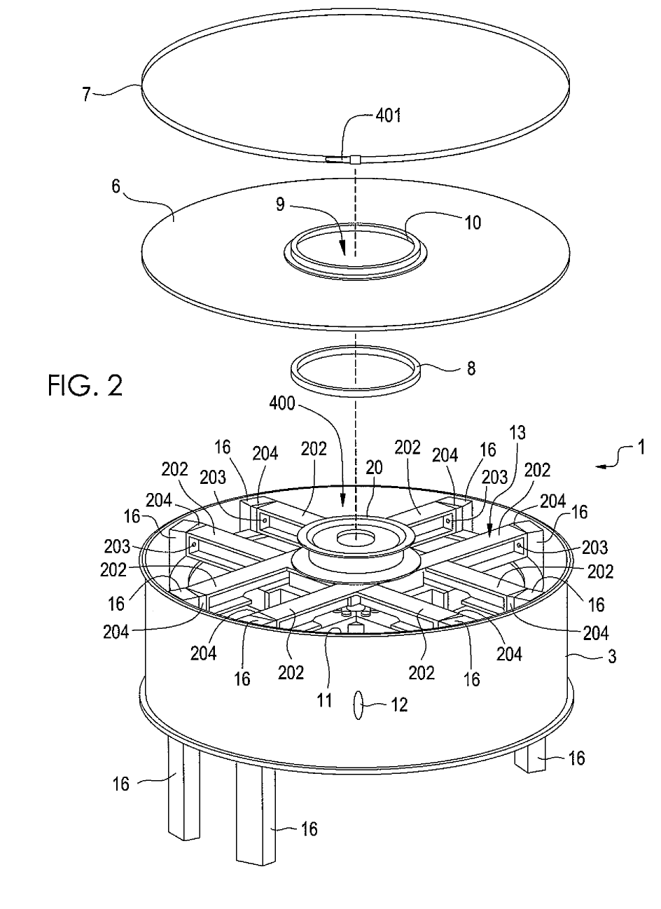

FIG. 2 depicts a partially exploded perspective top view of the MLS 1 depicted in FIGS. 1A-1F. Note that the MLS 1 depicted in FIG. 2 is an engine for use in a vehicle (not shown), e.g., an automobile or truck. However, the MLS 1 may be used in other devices, e.g., appliances, in other embodiments.

As noted hereinabove with reference to FIG. 1, the MLS 1 comprises the upper lid 6, the attachment ring 7, and the gasket 8. The upper lid 6 comprises an aperture 9 encircled by a flange 10.

In one embodiment, the upper cover gasket 8 is composed of an elastic-type material. Thus, when the MLS 1 is assembled, the gasket 8 couples to and securely grasps the flange 10. When the MLS 1 is assembled, the gasket 8 prevents undesirable foreign substances and/or objects from entering a cavity 400 formed by the upper lid 6, the barrel 3, and the lower cover 21 (FIG. 1E). Other beneficial characteristics and functions of the gasket 8 are described further herein.

The barrel 3 is cylindrically-shaped and slides over and surrounds the support rods 16. The barrel 3 prevents undesirable foreign substances and/or objects from interfering with the mechanical inter-working of the MLS 1 when the MLS 1 is assembled and rotating, which is described further herein.

In one embodiment, the barrel 3 is coated on its inside with a diamagnetic substance. The term “diamagnetic substance” refers to a substance that exhibits a low magnetic permeability and very slightly repels magnets. Coating the barrel 3 with a diamagnetic substance ensures that the forces created by the magnets within the MLS 1 will not penetrate the barrel 3.

Furthermore, the barrel 3 comprises a flange 11. The flange 11 receives the upper lid 6 and the upper attachment ring 7 couples the upper lid 6 to the barrel 3 when the attachment ring 7 is tightened about the flange 11. In one embodiment, the attachment ring 7 is a structure that is placed on the flange 11 in a unsecured state, and when a user (not shown) actuates a mechanism 401 on the attachment ring 7, the attachment ring 7 tightens about the upper lid 6 and the flange 11 thereby securing the upper cover lid 6 to the barrel 3. In one embodiment, the upper lid 6 is coated with a diamagnetic material, as described with reference to the barrel 3. The mechanism 401 may be, for example, a drum closure ring.

The MLS 1 further comprises an upper support frame 13 to which the closeout flange 20 is attached. In one embodiment, the upper support frame 13 comprises a plurality of crossbars 202. The crossbars 202 attach to respective support rods 16 that extend and attach to the frame (not shown), as described hereinabove. Note that the MLS 1 further comprises additional support rods 16 that may not extend through to the frame and are for local support of the infrastructure of the MLS 1. In one embodiment, each of the crossbars 202 is attached to at least one of the support bars 16 via one or more bolts 203.

Furthermore, because the ends of the support bars 202 that attach to the support rods 16 are not curved, one or more shims 204 intermediate the support rods 16 and the ends of the crossbars 202 may be used to effectively couple to and support the crossbars 202. Note that in such an embodiment, the bolts 203 would be inserted through the ends of the crossbars 202 and the shims 204 and coupled to the support bars 16. The crossbars 202 ensure that any movement made by the magnetic levitation assembly during operation is minimized.

Note that the support rods 16 may vary in length, as described hereinabove, in varying embodiments. In this regard, shorter support rods 16 may be used to support the barrel 3 of the MLS 1, and longer support rods 16 may, in addition, be used to mount the MLS 1 to the vehicle frame (not shown), for example, as described hereinabove.

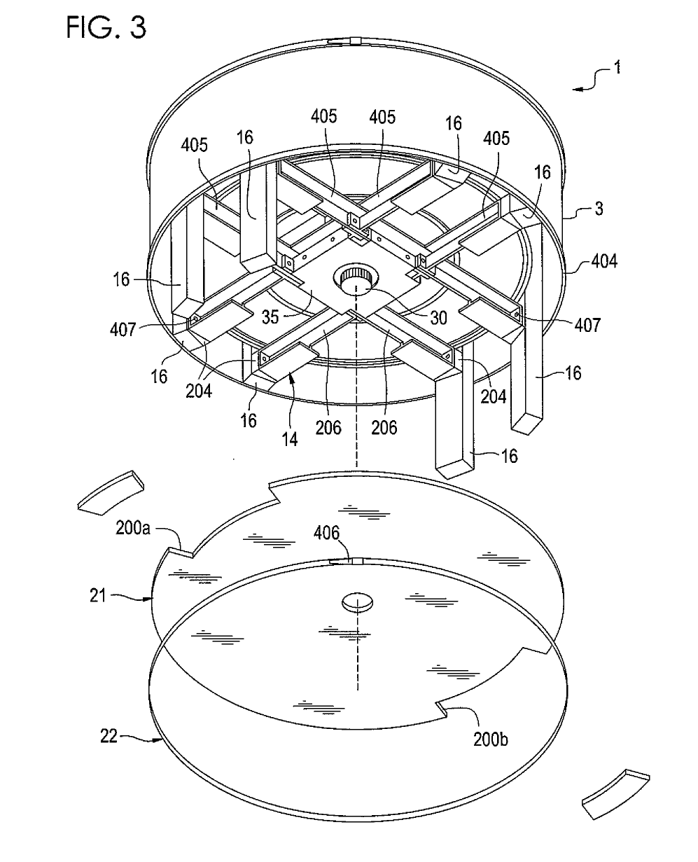

FIG. 3 depicts a partially exploded perspective bottom view of the MLS 1 depicted in FIGS. 1A-1F. The barrel 3 comprises a flange 404. The flange 404 receives the lower cover 21 and the attachment ring 22 couples the lower cover 21 to the barrel 3 when the attachment ring 22 is tightened. In one embodiment, the attachment ring 22 is a structure that is placed on the flange 404 in an unsecured state, and when a user (not shown) actuates a mechanism 406 on the attachment ring 22, the attachment ring 22 tightens about the lower cover 21 and the flange 404 thereby securing the lower cover 21 to the barrel 3. Note that the lower cover 21 may also be coated with a diamagnetic material, as described with reference to the barrel 3.

The MLS 1 further comprises a lower support frame 14 to which a lower bearing plate 35 is attached. In one embodiment, the frame 14 comprises a plurality of crossbars 206. The crossbars 206 attach to the support rods 16 that extend and attach to the frame (not shown), as described hereinabove. Furthermore, the crossbars 206 may attach to additional support rods 16 that may not extend through to the frame and are for local support of the infrastructure of the MLS 1, e.g., to support the barrel 3 during levitation and propulsion. In one embodiment, each of the crossbars 206 is attached to the support bar 16 via one or more bolts 407.

Furthermore, because the ends of the support bars 206 that attach to the support rods 16 are not curved, the shims 204 intermediate the support rods 16 and the ends of the crossbars 206 may be used to effectively couple to and support the crossbars 206, as described with reference to FIG. 2. Note that in such an embodiment, the bolts 407 would be inserted through the ends of the crossbars 206 and the shims 204 and coupled to the support bars 16. The crossbars 206 also further ensure that any movement made by the MLS 1 during operation is minimized.

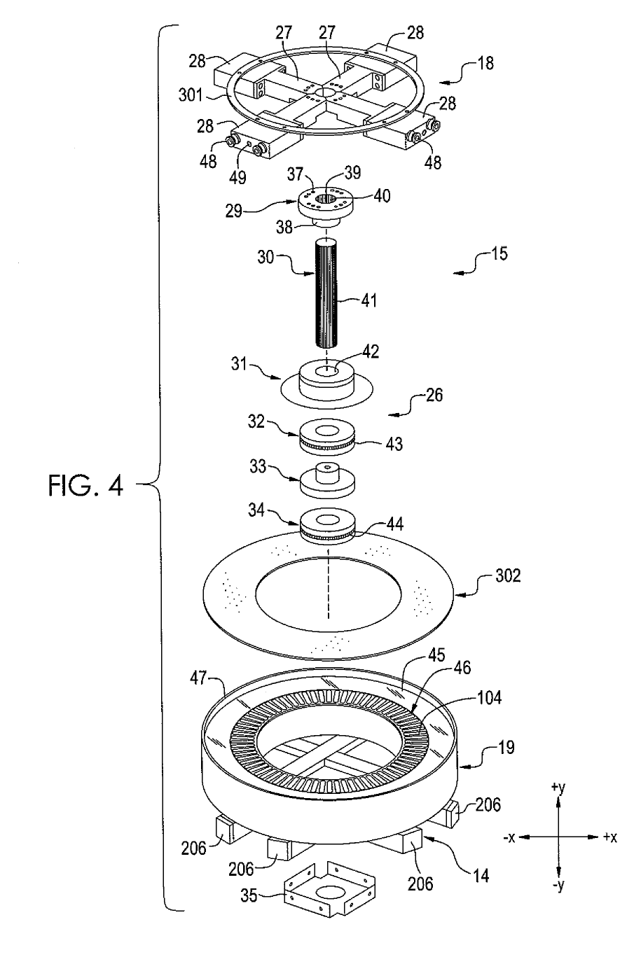

FIG. 4 depicts an exploded view of a portion of the MLS 1. In this regard, FIG. 4 depicts a levitation/propulsion assembly ring 19 coupled to one or more of the crossbars 206 of the lower support frame 14 and a rotating armature ring 18.

The rotating armature ring 18 comprises one or more armatures 27 coupled to one or more end effectors 28. In one embodiment, each end effector 28 is coupled to a respective armature 27. In other embodiments, the end effectors 28 and the armatures 27 may be unitary, for example a single member formed from metal casting.

Additionally, the end effectors 28 comprise at least one or more wheels 48, which rest on the ledge 47 of the levitation/propulsion assembly ring 19 when the MLS 1 is in an off position and the rotating armature ring 18 is at rest on the ledge 47. As described further herein, the rotating armature ring 18 levitates and propels radially along the levitation/propulsion assembly ring 19. As it is begins rotating, prior to levitation, the ring 18 is guided along the ledge 47 of the assembly ring 19.

Furthermore, the rotating armature ring 18 comprises a stabilization ring 301. The stabilization ring 301 couples to each of the end effectors 28, for example via bolts, and ensures that the rotating armature ring 18 remains stabilized during operation.

In one embodiment, each end effector 28 comprises at least one magnetic button 49. The magnetic button 49 emits magnetic forces, which can be positioned so as to emanate from the aperture 12 (FIG. 1), and a sensor (not shown) can use the forces emanating from the magnetic button 49 to determine the speed with which the rotating armature ring 18 is radially moving.

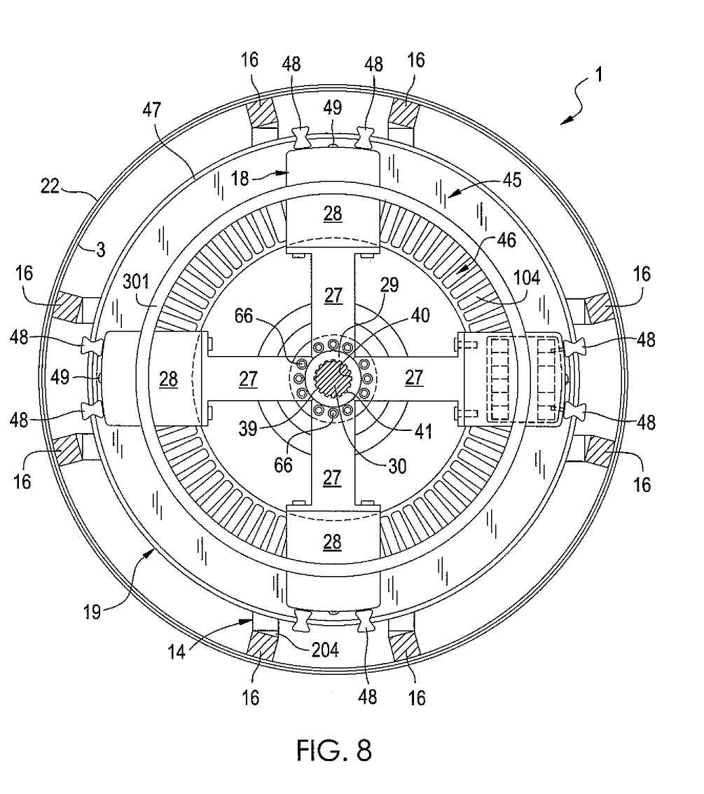

The levitation/propulsion assembly ring 19 is substantially cylindrically-shaped and houses levitation and propulsion tracks (not shown), which are described with reference to FIG. 8. In this regard, a plastic cover 302 covers the levitation and propulsion tracks.

The levitation/propulsion assembly ring 19 remains stationary during operation. In this regard, the starter generator 85 (FIG. 1A) initiates radial motion in the rotating armature ring 18. At a particular speed driven by the starter generator 85, the interaction between the levitation/propulsion assembly ring 19 and the armature ring 18, described in more detail herein, causes the rotating armature ring 18 to lift in a +y direction from an off position and levitate above the levitation/propulsion assembly ring 19 as the rotating armature ring 18 moves radially. The levitation/propulsion assembly ring 19 then begins to propel the rotating armature ring 18, and the starter generator is no longer needed to rotate the armature ring 18.

Note that “at off position” refers to the position when the rotating armature ring 18 is not moving radially or in a +y direction. Further note that the rotating armature ring 18 comprises a plurality of stabilization wheels 48. When the rotating armature ring 18 is off and at rest, the stabilization wheels 48 rest on a ledge 47 of the levitation/propulsion assembly ring 19.

In one embodiment, the propulsion described takes place when the radial speed of the of the rotating armature ring 18 reaches a particular speed, e.g., 5-7 revolutions per minute (rpm), which is the MLS 1 idle speed. Thus, the starter generator 85 initiates the movement and increases the speed of the rotating armature ring 18 until the rotating armature ring 18 begins to levitate above the levitation/propulsion assembly ring 19. Once levitation occurs in the rotating armature ring 18, the propulsion described takes over by the rotating armature ring 18 when a particular speed threshold is met.

Notably, the acceleration of the rotating armature ring 18 may be controlled, for example, by a driver (not shown) of a car depressing an acceleration pedal. If the driver depresses the acceleration pedal, the rotational speed of the armature ring 18 increases, and if the driver lets up on the acceleration pedal or depresses a brake (not shown), the rotational speed of the rotating armature ring 18 decreases. When the rotational speed of the rotating armature ring 18 decreases, the interaction between the levitation/propulsion assembly ring 19 and the rotating armature ring 18 is such that the rotating armature ring 18 beings to move in a −y direction until it ceases rotating altogether in the MLS 1 off position, and the rotating armature ring 18 rests on the rotating assembly ring 19.

Rotating armature ring 18 is coupled to the assembly ring 19 via a series of components. Notably, the splined flange 29 has an aperture 39 comprising splined walls 40, and the flange 29 has a plurality of bolt holes 37. The rotating armature ring 18 bolts to the splined flange 29 by bolts (not shown) inserted through a plurality of bolt holes 36 in the armatures 27 and the bolt holes 37 in the splined flange 29.

The splined shaft 30 comprises a splined outer surface 41, and the splined shaft 30 slidably fits within the aperture 29. The splined surface 41 mates with the splined walls 40 of the aperture 39. Notably, the splined shaft 30 is radially fixed with respect to the splined flange 29. Thus, when the starter generator causes the splined shaft 30 to rotate, the splined flange 29 rotates, which causes the rotating armature ring 18 to rotate.

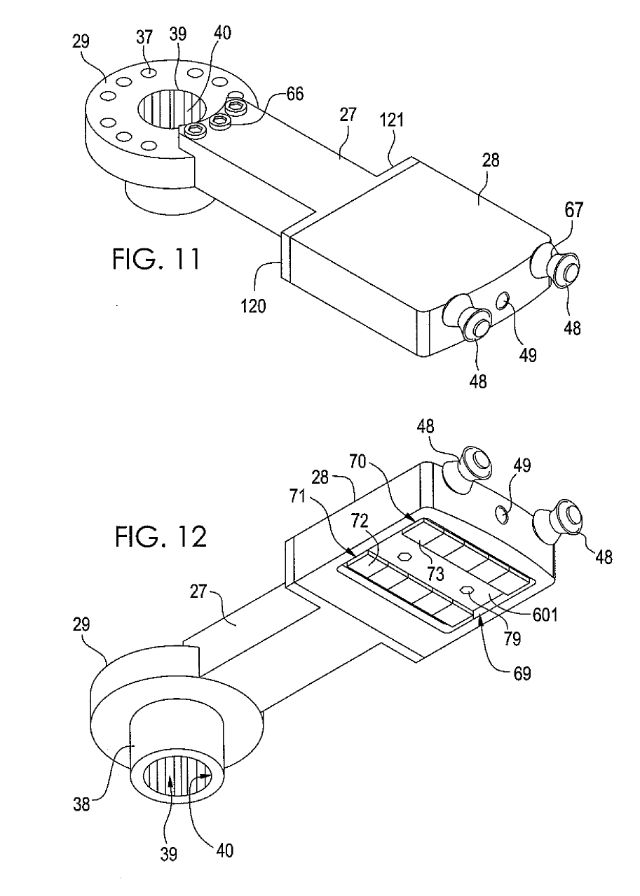

Note that the splined shaft 30 is vertically fixed with respect to the splined flange 29. Thus, the splined flange 29 can move vertically along the splined shaft 30 when the rotating armature ring 18 levitates, as described hereinabove. Thus, as the rotating armature ring 18 levitates, as described hereinabove, the splined flange 29 moves in a +y direction. Note that levitation occurs through interaction of magnets (not show) affixed to the end effectors 18, and such levitation and magnets are described with reference to FIGS. 11 and 12.

Likewise, as deceleration occurs, e.g., in a vehicle engine, the rotating armature ring 18 begins to move in a −y direction until the wheels 48 rest on the stationary rotating assembly ring 19, which is described further herein, as the MLS 1 off position.

The upper bearing cover 31 comprises an aperture 42, and the aperture 42 receives the splined shaft 30. In one embodiment, the upper bearing cover 31 mounts to the lower support frame 14. The bearing 32, comprises a plurality of rollers 43, for example, and the bearing 34, also comprises a plurality of rollers 44, for example. The bearings 32 and 34 are separated via the bearing flange 33.

The starter generator 85 (FIG. 1A) interfaces with the splined flange. In this regard, when the starter generator 85 initiates rotation, the splined flange 29 and the splined shaft 30 rotate, which is described in more detail herein. When the splined shaft 30 rotates, the armature ring 18 rotates. In this regard, the starter generator 85 causes rotational movement in the splined shaft 30, which causes rotational movement in the rotating armature ring 18.

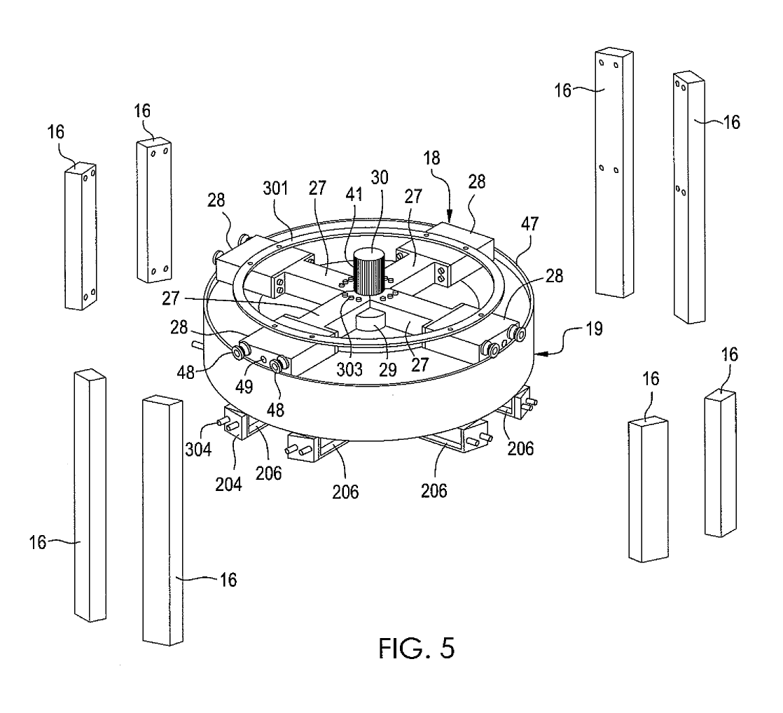

FIG. 5 depicts an assembled view of the armature ring 18 and the assembly ring 19. Notably, the armature ring 18 is in the MLS 1 off position, i.e., the wheels 48 are resting on the ledge 47 of the assembly ring 19. Furthermore, FIG. 5 depicts the support rods 16 exploded from the assembly ring 19. The support rods 16 are coupled to the lower frame 14 via one or more bolts 304 extending from the crossbars 206 of the lower frame 14.

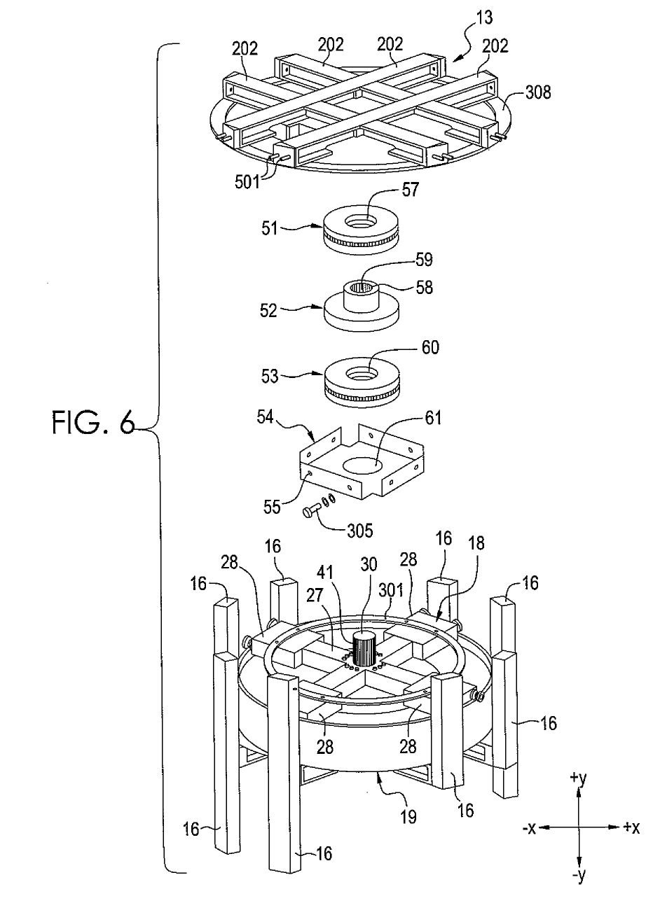

FIG. 6 depicts an exploded view of another portion of the MLS 1. In this regard, the upper frame 13 is coupled to the support rods 16 via a plurality of bolts 501 extending from the crossbars 202 of the upper frame 13. Furthermore, the upper frame 13 comprises an upper wheel guide 308. In this regard, when the armature ring 18 begins to levitate, the upper wheel guide 308 ensures that the rotating armature ring 18 does not move too far in the +y direction.

An upper bearing flange 52 separates an upper bearing 51 and a lower bearing 53. Further, the bearing cover 54 protects the movement of the bearings 51 and 53. The bearing cover 54 attaches to the upper support frame 13 via bolt holes 305 which correspond to bolt holes 55.

The shaft 30 receives the cover 54 via an aperture 61. Further, the shaft 30 receives the bearing 53, the flange 52, and the bearing 51 via respective apertures 60, 58, and 57. Note that the aperture 58 of the flange 52 comprises splined walls 59, which mate with the splined surface 41 of the splined shaft 30.

As the splined shaft 30 rotates, so does the bearing flange 52, because it is radially fixed with respect to the splined shaft 30. However, as the rotating armature ring 18 rotates and levitates, the bearing flange 52 can radially move with the splined shaft 30 and slidably move in the +y and −y direction along the splined shaft 30. Notably, as the splined flange 52 rotates, the bearings 51 and 53 reduce and mitigate frictional forces of the rotating splined flange 29.

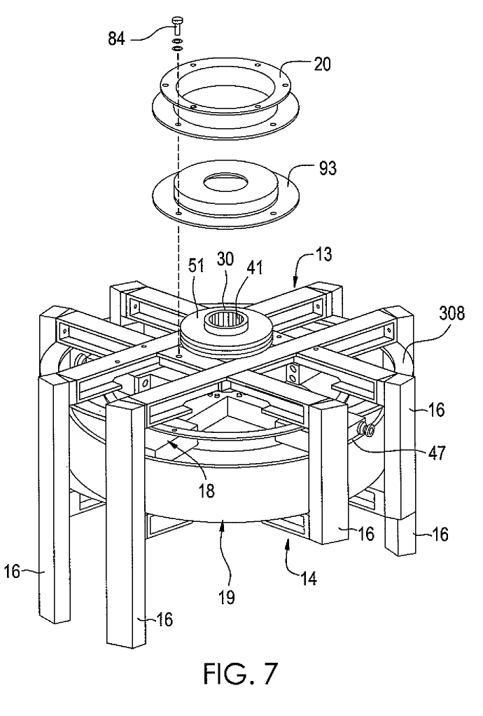

FIG. 7 depicts the lower support frame 14 coupled to the assembly ring 19 and the support rods 16. Further, FIG. 7 depicts the support rods 16 coupled to the upper support frame 13. Further, the upper bearing 51 couples to a bearing cover 93, which connects to the closeout flange 20. The closeout flange 20 is coupled to the bearing cover 93 and the upper support frame 13 via one or more screws or connectors 84.

Note that FIG. 7 depicts the armature ring 18 in the MLS 1 off position, as described hereinabove. In this regard, the wheels 48 are resting on the ledge 47 of the assembly ring 19.

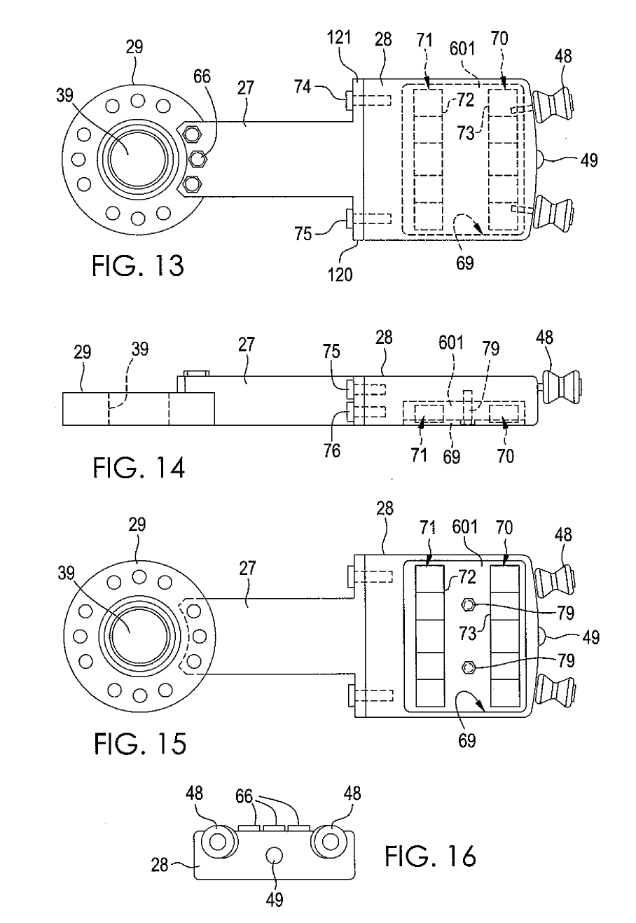

FIG. 8 depicts a top plan view of the levitation/propulsion assembly ring 19, which houses a propulsion track 45 and a levitation track 46. As will be described further herein, the effectors 28 house one or more magnets (not shown) that are exposed. Such magnets are shown and described further herein with reference to FIGS. 13-18. The levitation track 45 is comprised of a plurality of coils 104. In one embodiment, such coils 104 are made of wound coated copper wires.

The magnets magnetically interface with the propulsion track 45 and the levitation track 46. In this regard, the levitation track 46 magnetically and repulsively couples with one or more of the end effectors 28, which causes the rotating armature assembly 18 to levitate along the splined shaft 30 in a +y direction via the splined flange 29.

Furthermore, the end effectors 28 magnetically interface and couple with the profusion track 45. In one embodiment, the propulsion track 45 is a rail made of a magnetically repulsive material.

Once rotation is initiated by a starter generator (not shown), described further herein, the repulsive forces between the end effectors 28 and the propulsion track 45 cause the rotating armature ring 18 to move radially. Because the rotating armature ring 18 is fixedly attached to the splined flange 29 and the splined flange 29 radially and fixedly coupled to the splined shaft 30, when propulsion by the propulsion track 45 takes over, the propulsion track 45 causes radial motion in the splined shaft 30. Notably, in addition to the propulsion track 45 propelling the armature ring 18 radially, the levitation track 46 also continues to magnetically couple with the end effectors 28 so as to aid in propelling the armature ring 18.

Note that this rotation may be used in numerous ways. As an example, the splined shaft 30 may be connected to a transmission (not shown) of an automobile, which causes the vehicle to move. In addition, the splined shaft 30 may interface with the starter generator such that power is generated for recharging a vehicle battery (not shown) or controlling other devices and/or systems of the vehicle (not shown).

The assembly ring 19 further comprises the ledge 47, as described hereinabove. Each end effector 28 comprises at least one wheel 48, and each wheel 48 rests on the ledge 47 when the rotating armature ring 18 is not rotating, as described hereinabove.

As the rotating armature ring 18 begins to rotate, the wheels 48 ride along the ledge 47 until levitation occurs, i.e., when the end effectors 28 repulse the levitation track 46. Once the rotating armature ring 18 levitates due to the magnetic forces caused by the levitation track 45, the wheels 48 lift from the ledge 47. Note again that as the rotating armature ring 18 levitates it moves the +y direction along the splined shaft 30 because it is slidably affixed in the y-direction to the splined shaft 30. Notably, however, it is radially fixed with respect to the splined shaft 30 so that as the armature ring 18 rotates, so does the splined shaft 30.

As described hereinabove, the splined surface 41 of the splined shaft 30 (FIG. 4) mates with the splined walls 40 of the opening 39 in the splined flange 29. Furthermore, the armature 27 is attached to the splined flange 29 via the bolts 66, and the armature 27 is attached to the end effector 28 via the bolts 74 and 75.

As the splined shaft 30 rotates, the end effector 28 radially moves over the levitation track 46 and the propulsion track 45. When the speed with which the end effector 28 and the magnets 72 pass over the coils 104 of the levitation track 46 increases, e.g., to 5-7 rpm, each magnet 72 in the end effector 28 repels the coils 104, which causes each end effector 28 and corresponding armature 27 to levitate, thereby levitating the rotating armature ring 18 on the rotating splined shaft 30 (FIG. 4).

Furthermore, as the magnets 73 of the Halbach array 70 radially move over the propulsion track 45, the magnets 73 in the Halbach array 70 repel the wire coils 104 of the levitation track 45 and the magnetic material of the propulsion track 45 in such a way as to rotate the armature ring 18. In this regard, while a starter generator may initially be used to generate radial motion in the rotating armature ring 18, the magnetic interaction between the propulsion track 45 and the magnets 73 in the Halbach array 70 radially propels the rotating armature 18, the starter generator 85 continues to engage the shaft 30 to produce direct current (DC) power when the MLS 1 is in idle mode, i.e., 5-7 rpm.

FIG. 9 depicts a cross-sectional view of the armature ring 18 coupled to the levitation/propulsion assembly ring 19 like the depiction in FIG. 8. However, FIG. 9 depicts the plastic cover 302, which conceals and protects the levitation track 46 and the propulsion track 45.

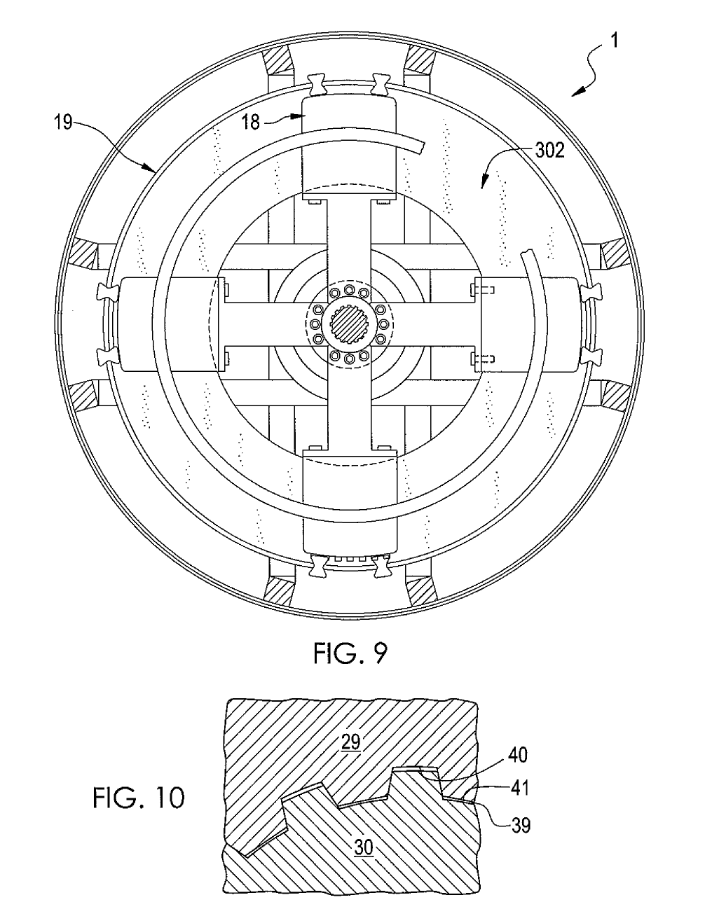

FIG. 10 is a drawing illustrating the splined surface 41 (FIG. 4) of the splined shaft 30 (FIG. 4) and its mating configuration with the splined walls 40 (FIG. 4) of the opening 39 (FIG. 4) in the splined flange 29 (FIG. 4).

FIG. 11 is a top perspective view of one of the end effectors 28 and its corresponding armature 27. As described hereinabove, each end effector 28 comprises at least one wheel 48. In one embodiment, the wheel 48 is hourglass-shaped, and a portion 67 of the hourglass shape exhibiting a smaller diameter rests and rides on the ledge 47 (FIG. 4) until the rotating armature ring 18 reaches a speed at which it levitates. In such an embodiment, the portion 67 exhibits a diameter that is smaller than the diameter of the remaining portions of the wheel 48.

As described hereinabove, the end effector 28 couples to the armature 27. The armature 27 comprises flanges 120 and 121, and a bolt, described further with reference to FIGS. 6-8, may be inserted in each of the flanges 120 and 121 in order to couple the effector 28 to the armature 27. Also as described hereinabove, the armature 27 couples to the splined flange 29. Such coupling may be effectuated by attaching one or more bolts 66 to the armature 27 and to one or more bolt holes 37 in the splined flange 29.

As described hereinabove, the splined flange 29 comprises an aperture 39. The walls 40 of the aperture 39 are splined and mate with the splined surface 41 of the splined shaft 30. Such mating ensures that the splined flange 29 and the splined shaft 30 (FIG. 4) move together radially, however, the splined flange 29 has freedom of movement along the +/−y direction via the splined mating between the surface 41 of the shaft 30 and the walls 40 of the aperture 39.

Each end effector 28 comprises the button magnets 49. Such button magnets 49 may be sensed via the apertures 12 (FIG. 1) in order to determine rotational speed and velocity of the moving parts of the MLS 1 by the central control instrumentation (not shown).

FIG. 12 depicts an underside perspective view of the effector 28 coupled to the armature 27, and the armature 27 coupled to the splined flange 29. The underside of the effector 28 comprises a recess 69. Within the recess 69 two Halbach arrays 70 and 71 are coupled to the end effector 28. Each of the Halbach arrays comprises a plurality of magnets 72. The number and position of the magnets 72 may vary in other embodiments.

During operation of the MLS 1, the magnets 73 in the array 70 interface with the propulsion track 45 (FIGS. 4 and 3). Furthermore, the magnets 72 in array 71 interface with the levitation track 46 (FIGS. 4 and 3). In this regard, the magnets 72 are repulsed by the coils 104 of the levitation track 46. When repulsion occurs, the magnets 73 are repulsed by the propulsion track 45, which rotates the rotating armature ring 18. When rotation in the rotation armature ring 18 (FIG. 4) reaches a particular speed, e.g., 5-7 rpm, the rotating armature ring 18 levitates along the splined shaft 30, as described hereinabove. Note that a “Halbach array” is a special configuration of permanent magnets which augments the magnetic field on one side of a device while canceling the field to near zero on the other side.

FIGS. 13-16 depict planar views of the end effector 28. FIG. 13 depicts a top planar view of the effector 28. The end effector 28 is coupled to the armature 27 via a plurality of bolts 74 and 75, which are attached to the flanges 121 and 120, respectively.

FIG. 14 depicts a side plan view of the end effector 28. The end effector 28 comprises the recess 69 in which one or more Halbach arrays 70 and 71 are inserted. The Halbach arrays 70 and 71 may be attached to a block 601 via, for example, an epoxy. The block 601 is then bolted to the end effector 28 via a bolt 79.

Furthermore, the end effector 28 may be attached to the armature 27 through the flanges 120 and 121 with the bolt 75, as depicted in FIG. 6. Alternatively, the effector 28 and the armature 27 may be coupled using a plurality of bolts, including an addition bolt 76.

FIG. 15 depicts an underside plan view of the effector 28. In one embodiment, the recess 69 is rectangular-shaped. The Halbach arrays 70 and 71 are attached to the block 601 via an epoxy, and the block 601 is secured to the end effector 28 via one or more bolts 79, thereby securing the arrays 70 and 71 in their particular positions. Note that the Halbach arrays 70 and 71 are mounted in the block 601 before being attached to the end effectors 28 via the mounting bolts 79.

FIG. 16 depicts an end plan view of the effector 28. The end effector 28 is coupled to two wheels 48. Further, the magnets 73 of the Halbach array 72 are indicated as protruding slightly from the top of the effector 28.

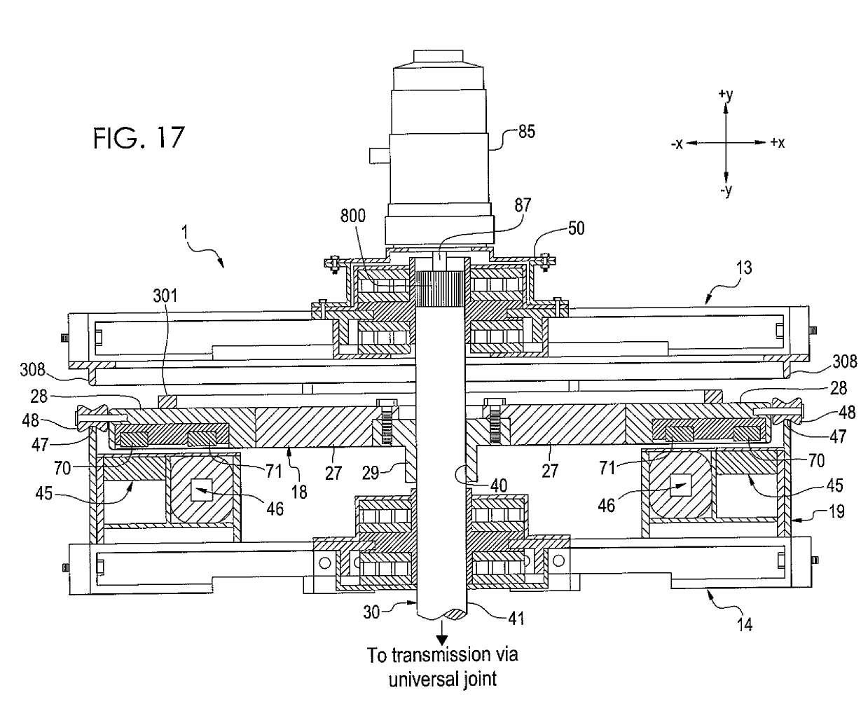

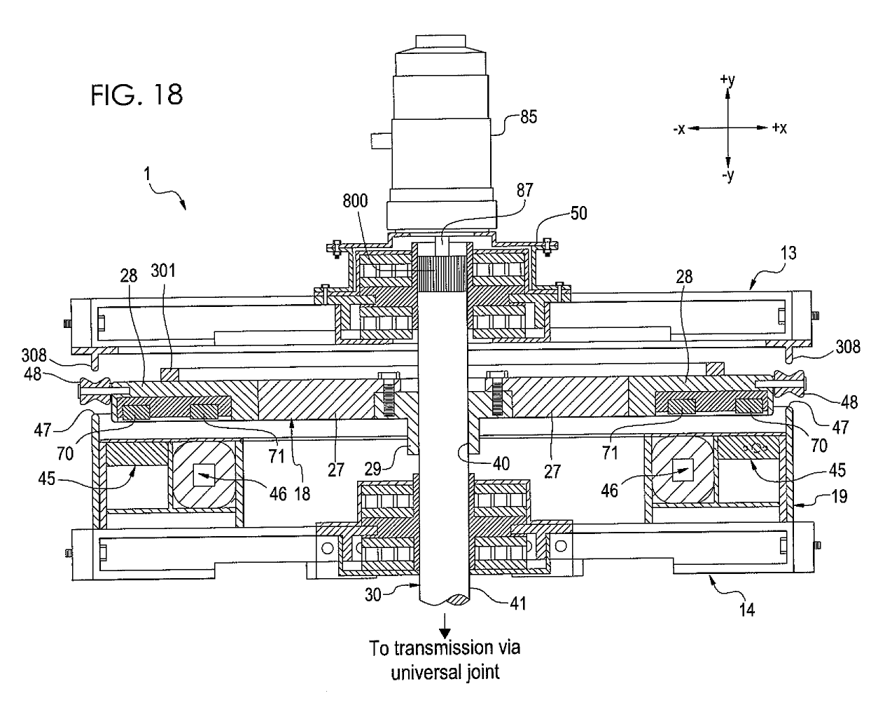

FIGS. 17 and 18 illustrate operation of the MLS 1 of the present disclosure.

FIG. 17 is a cross-sectional plan view of the MLS 1 (FIG. 1) when the MLS 1 is in the off position. In this regard, the rotating armature ring 18 is not rotating.

When a DC battery source (not shown) is provided to the starter generator 85, the starter generator 85 initiates rotation in the splined shaft 30, as described hereinabove. Further, the splined surface 41 of the splined shaft 30 slidably couples to the splined wall 40 of the splined flange 29. Further, the splined flange 29 is affixed to each armature 27 of the rotating armature ring 18.

During operation, a solenoid 87 of the starter generator 85 moves a gear 800 into the splined flange 29. Note that the shaft 30 also engages the splined flange 29, as described hereinabove. Such engagement can be done any number of ways known in the art.

As the starter/generator 85 rotates the gear 800, such rotation causes rotation in the shaft 30. When the shaft 30 rotates, the armature ring 18 rotates because the shaft 30 is radially fixed with respect to the armature ring 18. Note that as the armature ring 18 rotates with the shaft 30, the wheels 48 move along the ledge 47 of the assembly ring 19.

When the armature ring 18 reaches a particular speed, e.g., 5-7 rpm, the armature ring 18 levitates above the levitation track 46, as is depicted in FIG. 12. Note that when the armature ring 18 levitates, the wheel 48 levitates between the ledge 47 of the assembly ring 19 and the wheel stabilization guide 308 (FIG. 6).

When the rotation speed reaches the estimated idle mode, i.e., 5-7 rpm, the propulsion track 45 takes over and begins to generate a magnetic force acting on the armature ring 18 via the magnet arrays 70 and 71, the solenoid 87 de-couples from the shaft 30 and the starter/generator 85 produces DC power to the battery and the DC and AC subsystems (not shown) of the vehicle. Thereafter, the propulsion track 45 continues to propel the armature ring 18 as desired by the vehicle operation.

In one embodiment, the shaft 30 is connected at an end 200 to a transmission (not shown). The rotating motion generated by the rotating armature ring 18 can be transferred to the transmission via a universal joint (now shown) of a vehicle thereby rotating the vehicle wheels at desired speeds.

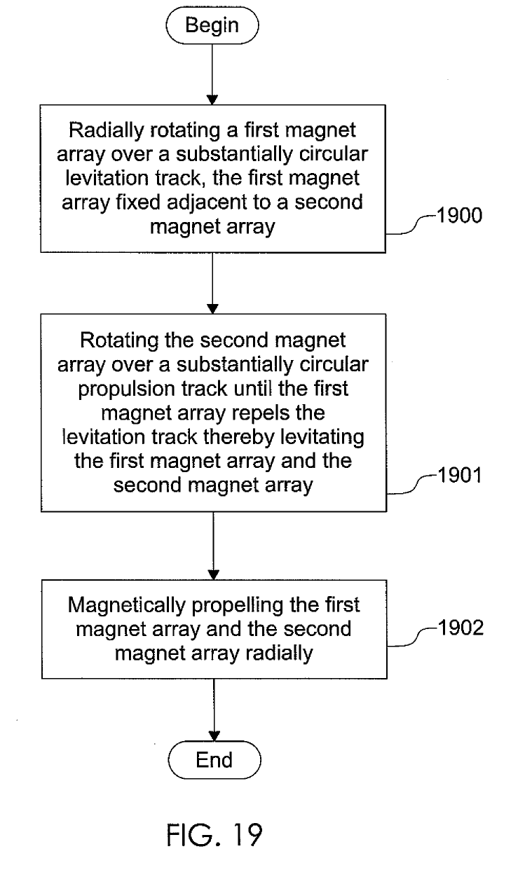

FIG. 19 depicts an exemplary magnetic levitation method in accordance with an embodiment of the present disclosure. In this regard, the first step in the magnetic levitation process of the present disclosure is radially rotating a first magnet array 71 (FIG. 13) over a substantially circular levitation track 45 (FIG. 4), as indicated in step 1900.

The next step is rotating a second magnet array 70 (FIG. 13) that is coupled to the first magnet array 71 over a substantially circular propulsion track 46 (FIG. 4) until the first magnet array 71 repels the levitation track 45, thereby levitating the second magnet array 70, as indicated in step 1901.

Finally, the last step is magnetically propelling the first magnet array 71 and the second magnet array 70 radially, as indicated in step 1902.

1. A magnetic levitation system, comprising:
a substantially circular levitation track, the circular levitation track magnetically repulsive;
a substantially circular propulsion track adjacent the levitation track, the propulsion track magnetically repulsive;
an end effector comprising a first array of magnets positioned to magnetically interface with the levitation track and a second array of magnets positioned to magnetically interface with the propulsion track thereby creating propelling magnetic forces;
a rotation device for radially rotating the end effector over the levitation track until the end effector levitates and reaches a threshold speed such that the propelling magnet forces generated by the second array of magnets and the propulsion track tend to propel the end effector radially.

2. The magnetic levitation system of claim 1, wherein at least one of the magnet arrays is a Halbach array.

3. The magnetic levitation system of claim 2, wherein the end effector is coupled to an armature and the armature coupled to a splined shaft such that as the armature rotates, the shaft rotates.

4. The magnetic levitation system of claim 3, wherein the armature is coupled to the splined shaft such that when the armature levitates, the armature and the end effector moves along the splined shaft.

5. The magnetic levitation system of claim 1, wherein the levitation track comprises a plurality of coils.

6. The magnetic levitation system of claim 1, wherein the propulsion track comprises a magnetically repulsive material.

7. The magnetic levitation system of claim 1, wherein the threshold is about 5 revolutions per minute (rpm) to 7 rpm.

8. The magnetic levitation system of claim 1, wherein the rotation device is a starter/generator.

9. The magnetic levitation system of claim 5, wherein the starter/generator interfaces with the rotating end effector when the end effector levitates such that the starter/generator produces direct current power for use by at least one subsystem.

10. The magnetic levitation system of claim 1, further comprising an interface to a transmission of a vehicle such that the radial rotation drives at least on wheel of the vehicle.

11. The magnetic levitation system of claim 1, further comprising a splined shaft fixedly coupled to the end effector.

12. A method, comprising:
rotating a first magnet array over a substantially circular levitation track, the first magnet array coupled to a second magnet array;
rotating the second magnet array over a substantially circular propulsion track until the first magnet array repels the levitation track thereby levitating the first magnet array and the second magnetic array;
magnetically propelling the first magnet array and the second magnet array radially.

13. The method of claim 12, wherein the first and second magnet arrays are fixedly interfaced with a spline system, the spline system comprising a splined shaft fixedly coupled to a splined flange, and wherein the radially rotating the first and second magnet arrays further comprises the step of:
rotating the splined shaft such that the first and second magnet arrays rotate.

14. The method of claim 13, wherein the splined shaft interfaces with a starter generator, further comprising the steps of:
applying power to the starter generator; and
rotating the splined shaft via rotational motion produced by the starter generator.

15. The method of claim 12, wherein the first magnet array and the second magnet array are coupled to a shaft assembly, further comprising the step of:
driving the shaft assembly via the rotational movement induced by the magnetic propulsion of the first and second magnet array.

16. The method of claim 12, wherein the driving the shaft step further comprises the step of driving a transmission of a vehicle via a universal joint coupling the shaft assembly to the transmission.

17. The method of claim 12, further comprising the step of limiting the height of levitation of the first magnet array and the second magnet array.

18. The method of claim 12, wherein the first and second array are coupled to an end effector and the end effector is coupled to an armature, further comprising the step of:
moving the end effector and the armature along a splined shaft thereby effectuating levitation.

19. The method of claim 18, further comprising the step of reducing friction caused by the rotating steps via at least one bearing.

20. A magnetic levitation system, comprising:
a substantially circular levitation track, the circular levitation track magnetically repulsive;
a substantially circular propulsion track adjacent the levitation track, the propulsion track magnetically repulsive;
an end effector comprising a first array of magnets positioned to magnetically interface with the levitation track and a second array of magnets positioned to magnetically interface with the propulsion track thereby creating propelling magnetic forces; and
means for rotating the end effector over the levitation track until the end effector levitates and reaches a threshold speed such that the propelling magnet forces generated by the second array of magnets and the propulsion track tend to propel the end effector radially.
